(19) United States
(12) Patent Application Publication
(10) Pub. No.: US 2016/0347329 A1
(43) Pub. Date: Dec. 1, 2016

(54) SITUATIONAL AWARENESS FOR A VEHICLE

(71) Applicant: GM GLOBAL TECHNOLOGY OPERATIONS LLC, Detroit, MI (US)

(72) Inventors: Ido Zelman, Ra'anana (IL); Omer Tsimhoni, Herzliya (IL)

(21) Appl. No.: 15/115,176

(22) PCT Filed: Jan. 28, 2014
(86) PCT No.: PCT/US14/13262

§ 371 Date: Jul. 28, 2016

(51) Int. Cl. B60W 50/16

(52) U.S. Cl. CPC B60W 50/16; B60N 2002/4485

(57) ABSTRACT

The present disclosure relates to a continuous sensory output system and haptic apparatus, including a processor and a computer-readable where the processor to performs operations including receiving a sensor signal containing a sensor data set, applying the sensor data sets to a filter of a software package to form a projection data set, delivering the projection data set to a controller to form an action data set, and performing the action data set to an implementation section to perform the sensory output. Also, disclosed are methods including receiving a sensor signal containing a sensor data set, applying the sensor data sets to a filter of a software package to form a projection data set, delivering the projection data set to a controller to form an action data set, and performing the action data set to an implementation section to perform the sensory output.

### TECHNICAL FIELD

The present technology relates to software that provides situational awareness during autonomous vehicle functions. More specifically, the technology provides situational awareness in the form of output to an operator during autonomous vehicle functions.

### BACKGROUND

When operating a vehicle, an operator must frequently monitor information sources within and outside of the vehicle, such as a speedometer and surrounding environment. Situational awareness systems have been developed to aid the operator in monitoring these sources using visual and/or auditory warning signals. As vehicles continue to include situational awareness systems that contain sensory and perceptual functions, as seen in active safety systems, additional human machine interaction may be necessary to keep the operator abreast of situations occurring within and outside of the vehicle.

However, many situational awareness systems only detect an instance or occurrence of an event, and do not detect such occurrences dynamically. The awareness systems may warn the vehicle operator when hazards are detected, for instance, but not provide updates continuously to the vehicle operator as conditions change.

Haptic output is a tool used in situational awareness systems to alert operators of conditions, such as when hazards are detected. Haptic output communicates through a user interface and a user's sense of touch. Haptic output is used in industries ranging from the cellular phone industry to the automotive industry.

Within the automotive industry, haptic output has been used to provide the operator with stimulation using vibration of vehicle components. One such system uses haptic vibration within the operator seat of the vehicle when a hazard is detected. The system, however, does not provide haptic output at other times.

### SUMMARY

A need exists for continuous output robustly at applicable or relevant times within a vehicle containing autonomous-control functions. The present disclosure relates to systems and methods for implementing continuous output to a vehicle operator robustly during applicable or relevant times.

In one aspect, the present technology includes a sensory output system, for use in a vehicle, including (1) a processor and (2) a computer-readable medium comprising computer-executable instructions including a situational software package, wherein the instructions, when executed by the processor, cause the processor to perform the operations of (i) receiving, from the situational software, by a controller component, a projection data set derived from a sensor data set, (ii) applying, to the projection data set, a controller filter of the controller component, to create an action data set, (iii) delivering, to an implementation component comprising at least one implementation section, the action data set by way of an action signal, and (iv) performing, by the at least one implementation section, the sensory output to a surface within the vehicle, perceived by an operator.

In some embodiments, the operation of receiving the projection data is repeatedly performed generally continuously with respect to various sensor data sets received during a time period in which the vehicle is operated.

In other embodiments, the operation of applying the controller filter to the projection data set further comprises applying, by the controller filter, an input data set.

In further embodiments, the data set is received from a source external to the sensory system.

In other embodiments, the operation of delivering the action data set to the at least one implementation section is generally continuously with respect to various action data sets received during a time period in which the vehicle is operated.

In yet other embodiments, the operation of performing the sensory output by the at least one implementation section is generally continuously with respect to various action data sets received during a time period in which the vehicle is operated.

In yet other embodiments, the at least one implementation section includes a plurality of controllers and a plurality of applicators, the implementation section being configured to, using the controllers and applicators, notify, based on the action signal, a vehicle operator of a situation indicated by the sensor data set.

In further embodiments, the implementation section is a first implementation section and the system comprises a plurality of implementation sections, including the first implementation section, wherein each implementation section receives, from the processor, by way of the action signal, an action to be implemented at the section.

In another aspect, the present technology includes a haptic apparatus, for use in a vehicle, including (1) an implementation section, including an applicator and (2) a computer-readable medium comprising computer-executable instructions including a situational software package, wherein the instructions, when executed by a processor, cause the processor to perform the operations of (i) receiving, from the situational software, by a controller component, a projection data set derived from a sensor data set, (ii) applying, to the projection data set, a controller filter of the controller component, to create an action data set, (iii) delivering, to an implementation component comprising the implementation section, the action data set by way of an action signal, and (iv) performing, by the implementation section, a sensory output to a surface within the vehicle, perceived by an operator.

In some embodiments, the applicator is located under a surface of a seat within the vehicle.

In some embodiments, the operation of receiving the projection data is repeatedly performed generally continuously with respect to various projection data sets received during a time period in which the vehicle is operated.

In other embodiments, the operation of delivering the action data set to the at least one implementation section is generally continuously with respect to various action data sets received during a time period in which the vehicle is operated.

In other embodiments, the operation of performing the sensory output by the implementation section is generally continuously with respect to various action data sets received during a time period in which the vehicle is operated.

In other embodiments, the implementation section including a plurality of controllers and a plurality of applicators, the implementation section being configured to, using the controllers and applicators, notify, based on the action signal, a vehicle operator of a situation indicated by the sensor data set.

In further embodiments, the implementation section is a first implementation section and the system comprises a plurality of implementation sections, including the first implementation section, wherein each implementation section receives, by way of the action signal, an action to be implemented at the section.

In a further aspect, the present technology includes a method, for implementation at a vehicle including (1) receiving, by a processor executing a situational software package, from a projection component, a projection signal containing a projection data set derived from a sensor data set, (2) applying, by the processor, to the projection data set, a controller component, to create an action data set, (3) delivering, by the processor, to an implementation component comprising an implementation including a plurality of applicators, the action data set, and performing, by the by the applicators, an action, derived from the action data set, to generate a sensory output to a surface within the vehicle, perceived by an operator.

In some embodiments, various sensor data sets are received in repeated receiving operations of sensor signals continuously over time, and the various sensor data sets represent varying extra-vehicle conditions.

In some embodiments, various projection data sets are created generally continuously, based on various projection data sets received, during a period of time in which the vehicle is operated.

In other embodiments, various action data sets are determined generally continuously, based on various action data sets created, during a period′ of time in which the vehicle is operated.

In other embodiments, various actions are performed generally continuously, based on various action data sets created during a period of time in which the vehicle is operated.

Other aspects of the present technology will be in part apparent and in part pointed out hereinafter.

### DESCRIPTION OF THE DRAWINGS

FIG. 1 illustrates a continuous output system for implementing situational software in accordance with an exemplary embodiment.

FIG. 2 illustrates an embodiment of a haptic output apparatus using the situational software of FIG. 1.

FIG. 3 is a top view of an implementation section within an output system depicted in FIG. 2.

FIGS. 4A-4C show exemplary waveforms of pressure output by implementation sections depicted in FIG. 2.

### DETAILED DESCRIPTION

As required, detailed embodiments of the present disclosure are disclosed herein. The disclosed embodiments are merely examples that may be embodied in various and alternative forms, and combinations thereof. As used herein, for example, exemplary, illustrative, and similar terms, refer expansively to embodiments that serve as an illustration, specimen, model or pattern.

Descriptions are to be considered broadly, within the spirit of the description. For example, references to connections between any two parts herein are intended to encompass the two parts being connected directly or indirectly to each other. As another example, a single component described herein, such as in connection with one or more functions, is to be interpreted to cover embodiments in which more than one component is used instead to perform the function(s). And vice versa—i.e., descriptions of multiple components described herein in connection with one or more functions are to be interpreted to cover embodiments in which a single component performs the function(s).

In some instances, well-known components, systems, materials, or methods have not been described in detail in order to avoid obscuring the present disclosure. Specific structural and functional details disclosed herein are therefore not to be interpreted as limiting, but merely as a basis for the claims and as a representative basis for teaching one skilled in the art to employ the present disclosure.

While the present technology is described primarily in connection with a vehicle in the form of an automobile, it is contemplated that the technology can be implemented in connection with other vehicles, such as marine craft and air craft.

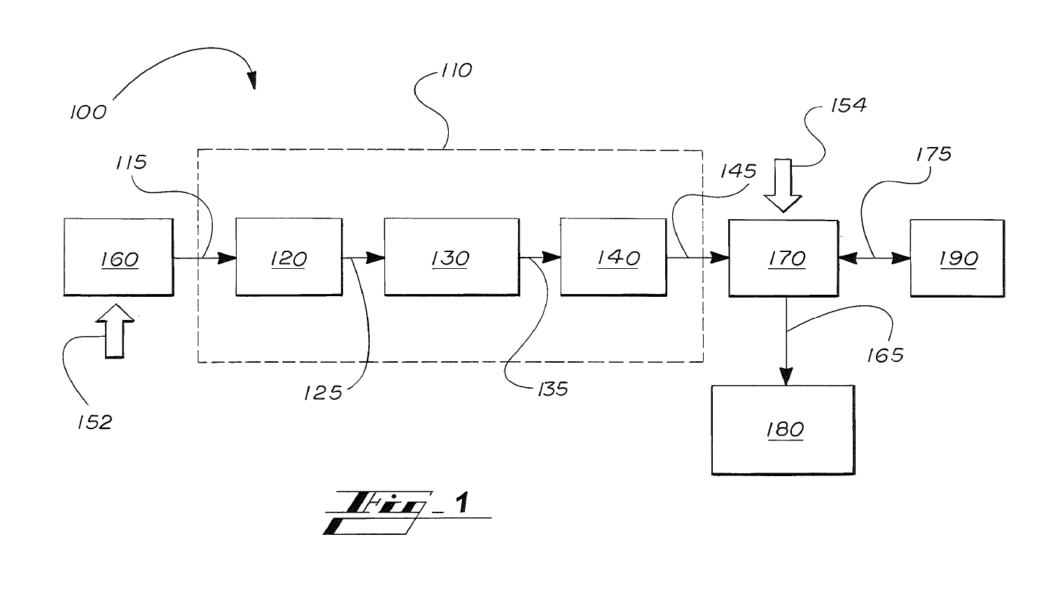

### I. OUTPUT SYSTEM—FIG. 1

Now turning to the figures, and more particularly the first figure, FIG. 1 illustrates a continuous sensory output system 100. While the system 100 is referred to as a continuous sensory output system, and operations of the system are described herein as occurring continuously, it should be appreciated that the system is not limited to operating at all times. In one embodiment, for instance, the system operates at all relevant times, such as during autonomous vehicle function. In one embodiment, the system operates at all relevant times, such as during such function while there is at least one obstacle or other hazard or potential hazard that the operator should be aware of.

The system 100 includes a measurement component 160, a situational software 110, a controller component 170, and an implementation component 180.

In one embodiment, the system 100 includes software and in another a combination of hardware and software. The hardware can include a processor for executing software embodied as computer-executable code or instructions. In one embodiment, a single processor executes code associated with any one or more of the various parts of the output system 100 shown and described. In a contemplated embodiment, at least two processors execute code to perform complimenting or related functions, such as by one processor, executing first instructions passing data to another processor that receives and processes the data by executing second instructions. The one or more processors can be internal to or connected to the system 100. The one or more processors may include, for instance, a processor of an onboard computer (OBC) of the vehicle. Thus, processing resources, for executing various computer-executable code of the present technology, may be shared or distinct amongst the parts of the system 100, and any of the one or more processors can be a part of or in communication with the system 100.

The measurement component 160 collects measurements, or sensor data, from one or more measuring devices, e.g., vehicle sensors. In one embodiment, one or more of the measuring devices are a part of the measurement component. In a contemplated embodiment, one or more of the devices are in communication with the measurement component 160.

The sensor data collected relates to conditions, which often vary, and the function of the measurement component 160 is to record the sensor data and monitor the variable conditions over time. The conditions can include conditions internal to the vehicle, e.g., tire pressure, or conditions external to the vehicle, e.g., atmospheric temperature. In one embodiment, the measurement component 160 is configured to process (e.g., reformat, arrange, etc.) the sensor data to generate what can be referred to as corresponding information, which can be referred to as variable information, sensor information, measurement data, measurement information, etc.

While output of the measurement component can include, depending on the embodiment, said sensor data, in essentially a raw state, as collected at the measurement component 160 from the measuring devices, and recorded at the component 160, or said corresponding sensor information generated, the output is referred to generally hereinafter as sensor data to simplify the present disclosure.

The sensor data is provided from the measurement component 160 via measurement signals 115 to the situational software 110. In one embodiment, the measurement component 160 includes or is in communication with a processor (not shown), as mentioned, for use in performing its functions, such as receiving, generating, and transferring sensor data.

The measuring devices, which can be part of the measurement component 160 and/or in communication with the component 160 as provided, are configured (e.g., made) and arranged (e.g., positioned and connected at locations of a vehicle) to measure desired conditions. The devices are in some embodiments configured and located to measure one or more of road conditions, weather conditions, and visibility, among others. The measuring devices can work together or independently. In one embodiment, it is preferred that at least two of multiple measuring devices operate independent of each other such that failure of one measuring device does not affect another.

Any of the measuring devices can be configured (e.g., programmed, or re-programmed) to make measurements at any desired interval of time, or cycle time. The cycle time can be constant or variable. The cycle time can vary based, for instance, on specific application needs. In one embodiment, the cycle time is between about 2 milliseconds and about 100 milliseconds.

Example measuring devices include vehicle speed sensors (e.g., wheel-rotation sensors), to measure speed of the vehicle. Another example of a type of measuring device is radar or another proximity sensor to measure separation distance to an object near the vehicle, such as obstacles during parking maneuvers. Proximity data can be used to determine speed or nearby objects, e.g., relative speed of nearby objects with respect to the subject vehicle.

The situational software 110 is a multilayer software architecture that includes a perception layer 120, a comprehension layer 130, and a projection layer 140. In some embodiments, the situational software 110 provides output signals, e.g. projection signal 145, continuously to be evaluated by the controller component 170. In other embodiments, the projection signal 145 is transferred from the situational software 110 intermittently, at irregular or regular intervals of time. The projection signals in some implementations include instructions to be executed by the implementation component.

The perception layer 120 receives the sensor data from the measurement component 160 via the measurement signals 115. While functions of system parts, such as the layers 120, 130, 140, and subcomponents thereof (e.g., filters, rules), the implementation component, etc., are described at times for simplicity as being performed by the parts, the functions are in various embodiments performed by one or more processors executing code of the part. Here, for instance, the perception layer 120 receiving the sensor data includes at least one processor, executing software of the perception layer, performing the receiving function.

The perception layer 120 applies a perception filter to the sensor data to formulate perception data. The filter may be configured to cause filtering based on any of a variety of inputs. In one embodiment, the perception layer 120, applying the perception filter, filters the sensor data according to operator input, e.g., input indicating that the vehicle operator engaged a turn signal.

The perception filter is applied to analyze the sensor data received by the measurement component 160. The perception filter includes a predetermined set of parameters used to determine which sensor data will be useful to the next, comprehension layer 130. For example, if the vehicle operator engages the vehicle right turn signal to indicate a right-hand turn, the perception filter may be configured to determine to provide to the comprehension layer 130 only the sensor data from the measurement devices corresponding to right side of the vehicle, or perhaps to the front and right side of the vehicle, or to the right of the vehicle and the front or side to at least a certain degree (e.g., to the front or right to a fore-aft centerline of the vehicle).

The comprehension layer 130 receives the perception data by a perception signal 125 from the perception layer 120. The function of the comprehension layer is to analyze the perception data and determine which perception data should be transferred to the, projection layer 140. The comprehension layer 130 applies a comprehension filter to the perception data to generate comprehension data.

While distinct acts of transferring and receiving data are described herein, in some embodiments some or all such acts include a processor generating the data, possibly caching or storing the data at least temporarily, and then using it. For instance, the disclosure provided of acts including transferring perception data from the perception layer, via signal 125, and receiving and processing the perception data at the comprehension data, includes the embodiment in which a processor generates the perception data, executing the software of the perception layer, possibly caching or storing the data, and then the processor processing, executing the software of the comprehension layer, the perception data generated.

The comprehension filter includes logic software to process the perception data. The processing can include creating a set of parameters that may be needed by the next, projection layer 140. The logic can include, e.g., data indicating traffic conditions and/or traffic dynamics. For example, the comprehension layer 130 may determine to transfer perception data that includes speed and/or acceleration of an approaching vehicle.

The projection layer 140 receives the comprehension data via a comprehension signal 135 from the comprehension layer 130. The projection layer 140 applies a set of projection rules to the comprehension data to generate projection data.

The projection rules may be configured to calculate an effect or effects, if any, that conditions indicated by the comprehension data (e.g., traffic conditions and/or dynamics) will have on the vehicle. Any determined effect(s) may be transferred by a projection signal 145 to the controller component 170. And any determined effect(s) identified may be updated subsequently, generally continuously, intermittently, or at regular intervals, and transferred by projection signals 145 to the controller component 170.

As an example, the projection rules may be configured to cause an executing processor to determine an effect of another vehicle approaching at an unsafe or at least high rate. In response to the determination, the projection rules may transfer, by means of the projection signal 145, a warning configured to alert (e.g., by audio/visual/haptic indicator) the driver of the situation, i.e., the presence of the other vehicle. The projection rules may transfer the projection signal 145 irrespective of whether the approaching vehicle may interfere with the vehicle operator's path—e.g., even if the approaching vehicle is in a different lane of traffic and/or does not pose an imminent threat of collision.

Once the projection rules are applied, the resulting projection data is transferred by the projection signal 145.

The controller component 170 receives the projection data via the projection signal 145 from the projection layer 140.

The controller component 170 may include or be a part of a central controller, or include or be a part of a set of multiple controllers. As with other parts of the system 100, the controller 170 can include or be in communication with a processor for executing code of the system. In one embodiment, the controller component 170 includes a processor executing code of other parts of the system 100, such as at least of the situational software 110. In this embodiment, the processor, still, can include, be, or be in communication with a broader vehicle processor, or OBC, as described more generally above. Thus, in at least one embodiment, the situational software 110 is operated by a controller separate and distinct from the controller component 170.

The controller(s) within the may include microcontrollers, microprocessors, programmable logic controllers (PLC), complex programmable logic devices (CPLD), field-programmable gate arrays (FPGA), or the like. The controller may be developed through use of code libraries, static analysis tools, software, hardware, firmware, or the like. Any use of hardware or firmware includes a degree of flexibility and high-performance available from an FPGA, combining the benefits of single-purpose and general-purpose systems. It will be apparent to a person skilled in the relevant art how the present technology can be implemented using one or more other computer systems and/or computer architectures.

The controller component 170 functions include transferring an action signal 165 to the implementation component 180 to carry out a desired action communicated to the controller component 170, such as alerting the vehicle operator of a situation. In one embodiment, the controller component 170 generates the action signal 165 based on input, e.g., the projection signal, from the projection layer 140.

In some embodiments, the vehicle operator may override the projection signal 145 produced by the situational software 110 by providing, one or more operator inputs 154 for receipt and processing at the controller component 170. The operator inputs 154 could be provided via human-machine interfaces, such as but not limited to touch-sensitive displays, microphones, a buttons, etc.

The operator inputs 154 may stop the projection signal 145 from being transferred to through the controller component 170 or alter the projection signal 145 before transferring it to the implementation component 180. For example, if the vehicle operator desires to receive haptic feedback in the form of a vibration, he may input his preference via any of the human-machine interfaces referenced above. The controller component 170 will receive his input and alter the projection signal 145, if necessary, prior to passing the projection signal 145 to the implementation component 180 to perform the vibration feedback request. As another example, if the vehicle operator desires not to receive any haptic feedback, he may input his preference via the human-machine interface. His input will stop the projection signal 145 from being transmitted by the controller component 170 to the implementation component 180. The controller component 170 may instead, transfer the projection signal 145 to a memory 190, described below.

In an override situation, when operator inputs 154 are provided, the controller component 170 implements commands of the operator input 154 rather than the projection signal 145 received from the situational software 110. The operator inputs 154 may include commands such as a command to turn on or off the system 100 when the system 100 would not have otherwise have automatically been turned on or off.

In some embodiments, the sensory output system 100 may include the memory 190 to store data received via memory signals 175 transferred from the controller component 170. The controller component 170 may also retrieve data from the memory 190 via memory signals 175.

The data stored to the memory 190 in some embodiments includes information communicated to the controller component 170, such as the operator inputs 154 and the projection data 145. The memory 190 may also store one or more profiles including settings such as personalization preferences, corresponding to one or more vehicle operators. The settings can include, e.g., preferred manners by which the operator will be notified of certain conditions or situations. One vehicle operator may prefer to be notified of an event by visual output in the form of warning light, for instance, whereas another vehicle operator may prefer to be notified of the event by haptic output in the form of a vibration.

Operator preferences may be communicated to the controller component 170 as the operator inputs 154, using the human-machine interfaces, described above. The controller component 170 may transmit operator preferences, via the memory signal 175, and the memory 190 may store those preferences. Operator preferences may also be recalled from the memory 190 and transmitted to the controller component 170 to be performed through the implementation component 180.

The controller component 170, determines what should be passed to the implementation component 180 by action signal 165. The determination in one embodiment includes selecting an action from among at least two of a command received from the situational software 110, a command received by an operator input 154, and information retrieved from the memory 190.

The implementation component 180 receives the action signal 165 and carries out the actions indicated therein.

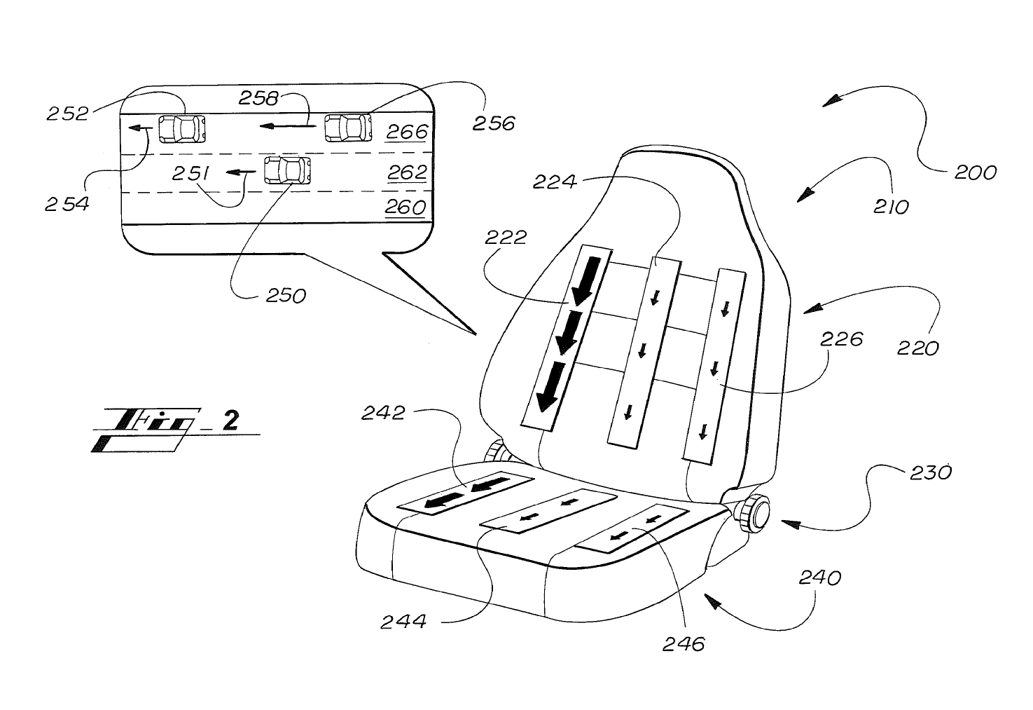

The implementation component 180 may include or be connected to notification, or communication, components configured to provide sensory communication or output to a user, such as haptic, auditory, or visual output. The implementation component 180 may include one or more implementation sections, shown, e.g., in FIG. 2.

The system 100 is configured to control timing of transmissions of data within the system 100, e.g., the signals 115, 125, 135, 145, 165, and 175. The system 100 may be set so that any or all of the transmissions occur generally continuously or at pre-determined intervals, whether regular or irregular, for instance. The setting in some embodiments depends on one more conditions, such as user input or environmental conditions. For example, one or more of the data transmissions may occur every about 30 milliseconds in normal weather conditions, e.g., when tire traction with the road is within a normal range, and every about 5 milliseconds for special weather conditions, such as rain or snow, when tire traction with the road is reduced. Additionally, the transmission of data can be set to run in response to a trigger, such as in response to occurrence of one or more specific events. For example, data transmission may occur only when the car is running, or while it is moving or at least in gear.

The sensory output system 100 can include one or more other devices and components within or in support of the sensory output system 100. For example, the situational software 110 may contain additional layers to filter data, e.g., adaptive planning software for path planning and obstacle avoidance; modeling software for modeling and applying actions of the vehicle operator; and context-aware software for modifying the behavior of the system 100 when changes occur to the vehicle, the road, the vehicle operator, or general environmental conditions, such as time of day. Additionally, each layer within the situational software 110 may be provided signals, e.g., the above-referenced controller signals 155, from the controller component 170.

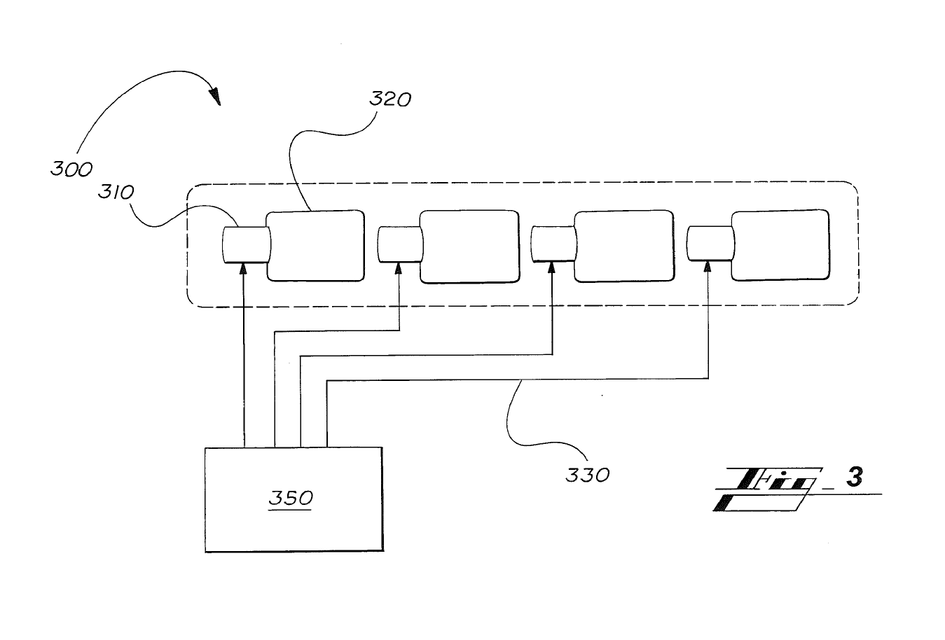

### II. EXAMPLE IMPLEMENTATION OF OUTPUT SYSTEM—FIGS. 2 AND 3

FIG. 2 illustrates an embodiment of a haptic apparatus 200 embodied in a vehicle seat. The apparatus 200 can include, or receive provided by execution of the signals from, the situational software of FIG. 1, and implements haptic output according to the signals.

The haptic output may include vehicle component (e.g., seat) movement, such as in the form of localized pressure, pulses, or vibrations, temperature differences, or other tactile output to be perceived by the vehicle operator.

The haptic apparatus 200 implemented by vehicle operator seat includes a headrest 210, a backrest 220, a connector fulcrum 230, and a base 240.

The haptic apparatus 200 may include implementation sections located on any part of the seat that may be perceived tactilely by the vehicle operator, e.g., the backrest 220 and the base 240. The implementation sections may be located under upholstery of the seat, just below the seat surface in contact with the vehicle operator.

One or more of multiple implementation sections can be operated independently or in some form of harmony or relationship with operation of other of the implementation sections. The implementation sections of the backrest 220 and the base 240 may be operated independently or in conjunction with each other.

One or more of the implementations sections can be associated in the system 200 with at least one related item. The related item can include, e.g., portions of the vehicle, areas around the vehicle, events, conditions, situations, etc. The implementation sections on the backrest 220, for instance, may correspond to sensors within a specific area of the vehicle, e.g., aft or rear area of the vehicle. Implementation sections on the base 240 may correspond to sensors on the fore positions of the vehicle.

In one embodiment, the backrest 220 includes a right implementation section 222, a middle or central implementation section 224, and a left implementation section 226. From the perspective of the vehicle operator, the right section 222 would create tactile output on the rear right side of the backrest 220. As provided, implementations sections can be associated in the system 200 with a related item, such as vehicle area. The systems 100/200 can be configured, for example, so that tactile output provided by way of the right section 222 based on information received by sensors on the right side of the vehicle. Similarly, the middle section 224 could create tactile output on the middle of the backrest 220 based on information received by sensors on the rear of the vehicle, and the left section 226 could create tactile output on the left side of the backrest 220 based on information received by sensors on the left side of the vehicle.

The base 240 may also include implementation sections. The systems 100/200 can be configured so that the implementations sections of the base 240 receive information from sensors on the front right side, the front, and the front left side of the vehicle. Specifically, from the perspective of the vehicle operator, a right base implementation section 242 will create tactical output at a right side the base 240, based on information received by the sensors on the right side (e.g., right front) of the vehicle. Similarly, a middle or central base implementation section 244 will create tactile output at a middle of the base 240 based on information received by the sensors on the front of the vehicle, and the left base implementation section 246 will create tactile output at the left side of the base 240 based on information received by the sensors on the left side (e.g., left front) of the vehicle.

In these ways, a vehicle operator sensing haptic output in the base 240 will know that a corresponding event, condition, or circumstance is present with respect to a corresponding vehicle area—e.g., front left, front, or front right, and, sensing haptic output in the backrest 220 will know that a corresponding event, condition, or circumstance is present with respect to a corresponding vehicle area—e.g., left, rear, or right.

In some embodiments, the implementation sections within the backrest 220 and the base 220 may be positioned to be parallel with the contact surface of the vehicle operator, as seen in FIG. 2. In some embodiments, the implementation sections within the backrest 220 and the base 220 may be positioned to be perpendicular with the contact surface of the vehicle operator.

These embodiments are provided by way of illustration and not to narrow scope of the present technology. For example, in another embodiment, the system 100/200 is configured to associate implementation sections of the backrest 220 with forward-focused events or conditions (e.g., those relating to a front left, front, or front right of the vehicle) and to associate implementation sections of the base 240 with rear-focused events or conditions, or vice versa.

Other variations are possible and contemplated. Such embodiments and variations can, instead or in conjunction, be implemented via other vehicle components, such as a steering wheel, speakers, lights, screens, etc.

The call out in FIG. 2 illustrates schematically an example scenario involving a subject vehicle 250, a first vehicle 252, and a second vehicle 256. The vehicles 250, 252, 256 are traveling in the same general direction along a surface containing a left lane 260, a center lane 262, and a right lane 266. The subject vehicle 250 is traveling at a speed 251, the first vehicle 252 is traveling at a speed 254, and the second vehicle 256 is traveling at a speed 258. As depicted by arrow direction and length, the first speed 254 is less than that of the second speed 258.

The haptic response to the displayed scenario is depicted within the backrest 220 and the base 240 of the subject vehicle 250. The scenario is perceived and comprehended by the output system 100—e.g., by a processor executing the situation software 110, within the subject vehicle 250.

The projection data is then transferred from the situation software 110 to the controller component 170 and carried out by the implementation component 180. The haptic response occurs by affecting one or more of the implementation sections 222-246 within the seat of the vehicle operator to provide, in response to a command or instruction within the action signals 165, tactile output to notify the operator of the subject vehicle 250 of current conditions, and/or of changing conditions.

One or more pieces of hardware within the implementation sections 222-246, described further below in connection with FIG. 3, are in one embodiment configured to provide various levels of pressure, frequency, and/or intensity to communicate changes within the environmental conditions to the vehicle operator continuously.

As seen in FIG. 2, the first, right-most implementation section 222 has a more intense arrow pattern than the middle and left implementation sections 224 and 226 corresponding to the higher pressure, frequency, and/or other higher intensity (e.g., temperature change). The difference is provided because the measurement component 160 detected a change in the environmental conditions on the right side of the subject vehicle 250. More specifically, the measurement component 160 of the subject vehicle 250 detected the first vehicle 252, moving the first speed 254, and the second vehicle 256, moving the second speed 258, behind and in the right lane 266.

Depending on the speed 251 and proximity of the subject vehicle 250 to the first vehicle 252 and the second vehicle 256, the haptic apparatus 200 may provide tactile output to the vehicle operator of the subject vehicle 250. As seen in the callout, the haptic apparatus 200 may approximately continually update the vehicle operator about surrounding traffic. The haptic apparatus 200 may also approximately continually update the vehicle operator in the event of danger detected by the situational software 110. For example, the haptic apparatus 200 may update the vehicle operator in the event that the first vehicle 252 attempted to change from the right land 266 to the center lane 266, thus causing danger to the subject vehicle 250.

Although the implementation sections described are located within a vehicle seat, the technology may instead or also be implemented in other areas of a vehicle that may be perceived haptically by the vehicle operator, such as but not limited to a steering wheel, an arm rest, a seat belt, a headrest, a headset, or a gear shift.

FIG. 3 is a top view of an example implementation section 300 for use in a haptic output apparatus 200, e.g., implementation section 222, described above. In one embodiment, the implementation section 300 includes one or a plurality of controllers 310 aligned in contact with a plurality of applicators 320. In one embodiment, the controller(s) 310 are part of the controller component 170 described in FIG. 1. In one embodiment, the applicators 320 are part of the implementation component 180 described in FIG. 1.

In certain embodiments, some of the steps of the controller component 170 may be performed by a processor 350. The processor 350 may transfer a signal 330 to each controller 310. Each signal 330 may include commands from the situational software 110, the operator inputs 154, or the memory 190.

The processor 350 may be a computer processor, executing computer-executable instructions, corresponding to one or more corresponding algorithms, and associated supporting data stored or included on a computer-readable medium, such as the computer-readable memory 190 described above. Each implementation section may have its own processor, or the entire haptic output apparatus 200 may receive signals from a single processor.

In some embodiments, the applicators 320 include pockets of a fluid (e.g., a gas and/or liquid). The applicators 320 further include or in communication with one or more actuators, such as a pump (not shown) to control pressure within each pocket.

In these pocket embodiments, the pockets may contain gases such air, nitrogen, or the like and/or liquids such as water, silicon, or the like. Additional additives such as sodium chloride may be used to create phase change materials or other desirable characteristics. An ideal pocket composition would not be combustible under pressure and would have minimal thermal expansion/contraction with changing conditions.

The pump(s) may be an electrical pump(s) used to engage the pockets to increase/decrease pressure, intensity, size, etc. of the pockets. The electrical pump(s) may be wired to a central component so that the controller component 170 may communicate with each pump. The tube pressure within each pump may be operated by a wave signal, which creates the haptic output perceived by the operator.

In other embodiments, the applicators 320 include other output devices, such as actuators generating haptic output without fluid pockets. For example, a chain of actuators may be located within each implementation section to generate different levels of pressure on the seat surface in contact with the vehicle operator. The actuators may be electric, pneumatic, or the like, which move up and down, or in and out, etc., such as of the driver seat, thereby generating pressure, pulses, vibrations, or other output to the operator.

In some embodiments, a pressure sensor (not shown) is integrated together with the applicator 320. The pressure sensor allows added functionality of the applicator 320.

First, using pressure sensors in conjunction with the applicators 320 allows the implementation section 300 to determine the points of contact of the applicator 320 with the vehicle operator's back. These points of contact can be used to evaluate the dimensions of a vehicle operator's back and recalibrate the applicators 320 to better map to the drivers back. For example, if the vehicle operator is short in stature, the implementation section 300 may deactivate the actuators 320 located in the top of the backrest 220.

Additionally, using pressure sensors in conjunction with the applicators 320 allows the implementation section 300 to produce precise activation patterns that are personalized for each vehicle operator. Furthermore, by sensing the level of pressure in the points of contact, the implementation section 300 may calibrate the level of pressure exerted by the actuators 320 to fit the physiology or clothing of the vehicle operator.

As referenced, in some embodiments haptic output includes temperature, temperature gradients, temperature changes, or the like. The system 200 can include any suitable structure to raise or lower temperature of a vehicle component, e.g., steering wheel or seat. The structure can include, e.g., electrical heating elements.

As also referenced, more than one type of output, such as vibration and temperature-based output, can be provided separately or in harmony or conjunction, whether via the same or distinct vehicle components.

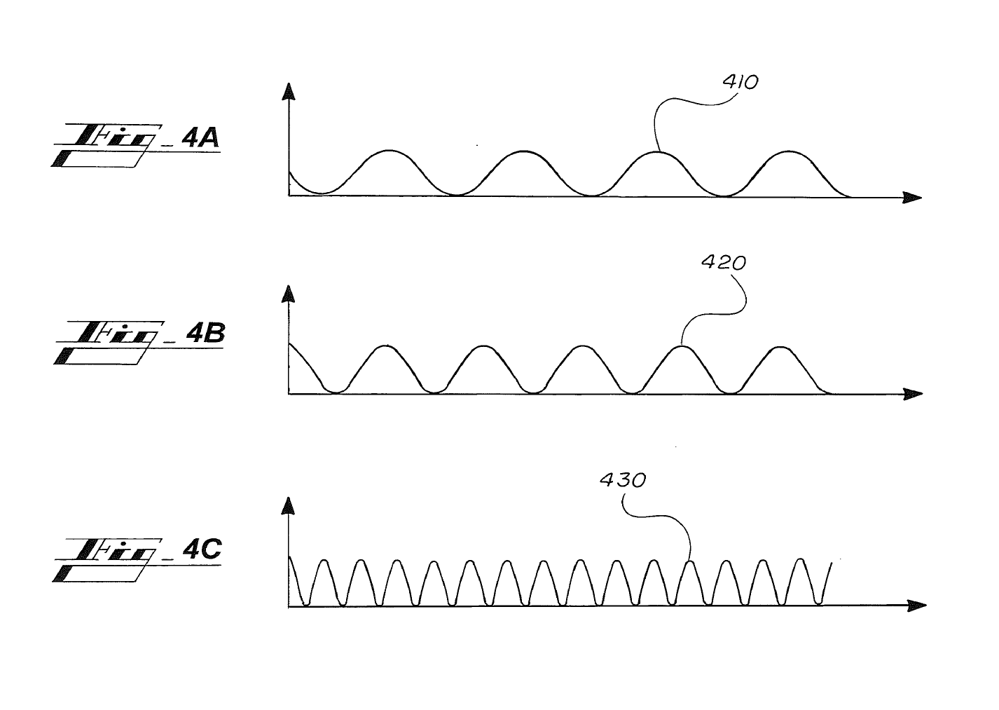

### III. EFFECT OF OUTPUT SYSTEM—FIG. 4

FIGS. 4A-4C illustrate, respectively, waveforms 410, 420, 430 of example output pressure of the implementation sections depicted in FIGS. 2 and 3. Waveform amplitude is indicated against the y-axis as a function of time, x-axis, for a specific applicator (e.g., an applicator 320). Time intervals may be measured in milliseconds or seconds.

The first example waveform 410 corresponds to a first implementation section that is providing relatively minimal output, e.g., implementation section 226 or 246. The second example waveform 420 corresponds to a second implementation section that is providing relatively-moderate tactile output, e.g., implementation sections 224 or 244, and the third example waveform 430 may correspond to an implementation section providing relatively-intense tactile output, e.g., implementation sections 222 or 242.

In some embodiments, the systems 100/200 described herein, generates the waveforms 410, 420, 430, or data related to or that can be represented by them, as part of generating action signals 165 for controlling operation of one or more haptic-output implementation components 180. The implementation components 180 would be configured to, and thus controlled to, provide haptic feedback according to waveform data, data corresponding to the generated waveforms, data that can be represented by the waveforms, etc.

The apparatus described herein can be configured to generate waveforms having any of numerous shapes and amplitudes using a controller (e.g., 310) and applicators (e.g., 320).

The waveforms 410, 420, 430 are in some embodiments generated or produced as a function of environmental inputs 152. The waveforms (y) can be generated, e.g., as a function of vehicle position on the road (x̅) and time (t), where x̅ is a 2 dimensional vector (x1, x2) referring to the lateral and longitudinal dimensions of a surface (e.g., a road). In a particular case, the relationship can utilize the general form of a sine wave function:

y(x̅,t)=A*sin(ωt−kx̅+φ)+D,

where A is amplitude, which is the peak deviation of from zero; ω is angular frequency, i.e., twice the regular frequency (f) multiplied by pi, where regular frequency is the number of oscillations that occur within each unit of time; k is the wave number; φ is a phase at t=0; and D is an amplitude offset of the wave.

In some embodiments, the parameters tied directly to the sine function (e.g., ω, k, and φ) are related to the frequency of wave changes in space and time. In some embodiments, the parameters tied directly to the sine function are related to the amplitude of wave changes in space and time. In yet other embodiments both the frequency and amplitude change in space and time. The parameters that supplement the sine function (e.g., A and D) are related to the motion and intensity level of the applicators 320.

For example, the function generates a dynamic waveform to create varying levels of pressure intensity and frequency based on dynamic traffic conditions—e.g., traffic density within a spatial area. More specifically, the dynamic waveform specifies pressure of the applicators 320 based on the environmental inputs 152, which are measured/recorded by the sensor system 160.

The function may also be used to superposition, or superimpose, waves to create more-elaborate haptic output. For example, the signals 330 (FIG. 3) sent by the processor 350 may provide instructions requiring that multiple waveforms be generated by the same applicator 320. Those multiple waveforms may be offset from one another or differ in amplitude or other sine wave function variable.

As shown in FIGS. 4A-4C, the first waveform 410 has a lower frequency than the second waveform 420 for the illustrated period of time. Similarly, the second waveform 420 has a lower frequency than the third waveform 430. As referenced, the frequency difference (pulse, vibration) can be tailored according to a pre-set protocol to notify the driver of a present condition, event, or situation, or situation or aspects of the condition, event, or situation.

As also referenced, the haptic output level, e.g., amplitude, temperature, volume, brightness, color, etc., can be tailored according to a pre-set protocol to notify the driver of a present condition, event, or situation or aspects of the condition, event, or situation. In some implementations, e.g., haptic output to alert the vehicle operator of an actual event is provided at a greater magnitude—e.g., with a larger wave height—than haptic output when no such event occurs,—e.g., a smaller wave height, or when the event is less severe—e.g., a nearby vehicle is farther away.

### IV. BENEFITS AND ADVANTAGES

Many of the benefits and advantages of the present technology are described herein above. The present section presents, in summary, some of the benefits of the present technology.

The technology allows provision of continuous output to the vehicle operator during at least relevant or applicable times, such as continuously during a lane switch, or lane centering, operation, while another vehicle or object is approaching quickly, etc.

Providing the vehicle operator with relevant and timely information, especially continuous information, increases his/her situational awareness during semi-autonomous or autonomous driving. Situational awareness also may prevent an operator from being startled by an alert that is used only to warn about an event (or potential event) rather than continuous output.

The technology can be used in conjunction with autonomous or semi-autonomous vehicle applications including adaptive cruise control (ACC), autonomous parking, etc. When ACC is engaged, the present technology operates with the ACC to implement functions such as vehicle acceleration, deceleration, lane centering, and changing lanes, among others.

### V. CONCLUSION

Various embodiments of the present disclosure are disclosed herein. The disclosed embodiments are merely examples that may be embodied in various and alternative forms, and combinations thereof.

The law does not require and it is economically prohibitive to illustrate and teach every possible embodiment of the present technology. Hence, the above-described embodiments are merely exemplary illustrations of implementations set forth for a clear understanding of the principles of the disclosure.

Variations, modifications, and combinations may be made to the above-described embodiments without departing from the scope of the claims. All such variations, modifications, and combinations are included herein by the scope of this disclosure and the following claims.

What is claimed is:

1. A sensory output system, for use in a vehicle, comprising:
a processor; and
a computer-readable medium comprising computer-executable instructions including a situational software package, wherein the instructions, when executed by the processor, cause the processor to perform operations comprising:
obtaining a sensor data set indicating a situational characteristic sensed by a vehicle sensor;
receiving, from the situational software, by a controller component, a projection data set derived from the sensor data set;
applying, to the projection data set, a perception filter of the controller component, to create a perception data set;
applying, to the perception data set, a comprehension filter of the controller component, to create a comprehension data set;
applying, to the comprehension data set, a projection filter of the controller component, to create an action data set;
delivering, to an implementation component comprising an implementation section, the action data set by way of an action signal; and
initiating, by the implementation section, providing sensory output to a surface within the vehicle to be perceived by an operator.

2. The system of claim 1, wherein the operation of receiving the projection data is performed generally continuously with respect to various sensor data sets received during a time period in which the vehicle is operated.

3. The system of claim 1, wherein the operation of applying the perception filter to the projection data set further comprises applying, by the perception filter, an input data set.

4. The system of claim 3, wherein the data set is received from a source external to the sensory output system.

5. The system of claim 1, wherein the operation of delivering the action data set to the implementation section is generally continuously with respect to various action data sets received during a time period in which the vehicle is operated.

6. The system of claim 1, wherein the operation of initiating the sensory output by the implementation section is generally continuously with respect to various action data sets received during a time period in which the vehicle is operated.

7. The system of claim 1, wherein the implementation section includes a plurality of controllers and a plurality of applicators, the implementation section being configured to, using the controllers and applicators, notify, based on the action signal, a vehicle operator of a situation indicated by the sensor data set.

8. The system of claim 7, wherein the implementation section is a first implementation section and the system comprises a plurality of implementation sections, including the first implementation section, wherein each implementation section receives, from the processor, by way of the action signal, an action to be implemented at the section.

9. A haptic apparatus, for use in a vehicle, comprising:
an implementation section including an applicator; and
a computer-readable medium comprising computer-executable instructions including a situational software package, wherein the instructions, when executed by a processor, cause the processor to perform operations comprising:
obtaining a sensor data set indicating a situational characteristic sensed by a vehicle sensor;
receiving, from the situational software, by a controller component, a projection data set derived from the sensor data set;
applying, to the projection data set, a perception filter of the controller component, to create a perception data set;
applying, to the perception data set, a comprehension filter of the controller component, to create a comprehension data set;
applying, to the comprehension data set, a projection filter of the controller component, to create an action data set;
delivering, to an implementation component comprising an implementation section, the action data set by way of an action signal; and
initiating, by the implementation section, providing sensory output to a surface within the vehicle to be perceived by an operator.

10. The apparatus of claim 9, wherein the applicator is located under a surface of a seat within the vehicle.

11. The apparatus of claim 9, wherein the operation of receiving the projection data is repeatedly performed generally continuously with respect to various projection data sets received during a time period in which the vehicle is operated.

12. The apparatus of claim 9, wherein the operation of delivering the action data set to implementation section is generally continuously with respect to various action data sets received during a time period in which the vehicle is operated.

13. The apparatus of claim 9, wherein the operation of performing the sensory output by the implementation section is generally continuously with respect to various action data sets received during a time period in which the vehicle is operated.

14. The apparatus of claim 9, wherein the implementation section including a plurality of controllers and a plurality of applicators, the implementation section being configured to, using the controllers and applicators, notify, based on the action signal, a vehicle operator of a situation indicated by the sensor data set.

15. The apparatus of claim 14, wherein the implementation section is a first implementation section and the system comprises a plurality of implementation sections, including the first implementation section, wherein each implementation section receives, by way of the action signal, an action to be implemented at the section.

16. A method, for implementation at a vehicle, comprising:
receiving, by a processor executing a situational software package, from a projection component, a projection signal containing a projection data set derived from a sensor data set;
obtaining a sensor data set indicating a situational characteristic sensed by a vehicle sensor;
receiving, from the situational software, by a controller component, a projection data set derived from the sensor data set;
applying, to the projection data set, a perception filter of the controller component, to create a perception data set;
applying, to the perception data set, a comprehension filter of the controller component, to create a comprehension data set;
applying, to the comprehension data set, a projection filter of the controller component, to create an action data set;
delivering, to an implementation component comprising an implementation section, the action data set by way of an action signal; and
initiating, by the implementation section, providing sensory output to a surface within the vehicle to be perceived by an operator.

17. The method of claim 16, wherein various sensor data sets are received in distinct receiving operations, of receiving sensor signals over time, and the various sensor data sets represent varying extra-vehicle conditions.

18. The method of claim 16, wherein various projection data sets are created generally continuously, based on various projection data sets received, during a period of time in which the vehicle is operated.

19. The method of claim 16, wherein various action data sets are determined generally continuously, based on various action data sets created, during a period of time in which the vehicle is operated.

20. The method of claim 16, wherein various actions are performed generally continuously, based on various action data sets created while the vehicle is operated.
